(19) United States
(12) Patent Application Publication
(10) Pub. No.: US 2012/0218422 A1
(43) Pub. Date: Aug. 30, 2012

(54) METHOD OF TRANSMITTING AUDIO AND VIDEO STREAMS IN REAL TIME

(75) Inventor: Samy BENHELLAL, Christol-Les-Ales (FR)

(73) Assignee: VIEWLAN, Ales Cedex (FR)

(21) Appl. No.: 13/364,981

(22) Filed: Feb. 2, 2012

(30) Foreign Application Priority Data
Jul. 28, 2009 (FR) FR 09 55255

(51) Int. Cl. H04N 5/225

(52) U.S. Cl. 348/207.1; 348/E05.024

(57) ABSTRACT

The present invention provides a method of transmitting digital streams of audio data and of video data in real time via a computer type communications network, said transmission taking place directly from a transmitter terminal, like a video camera, to a remote terminal for receiving and playing back said data, wherein the method consists in: transmitting only the video data stream via a first communications port of said network; and under the action of said remote terminal, transmitting the audio stream separately via a second communications port.

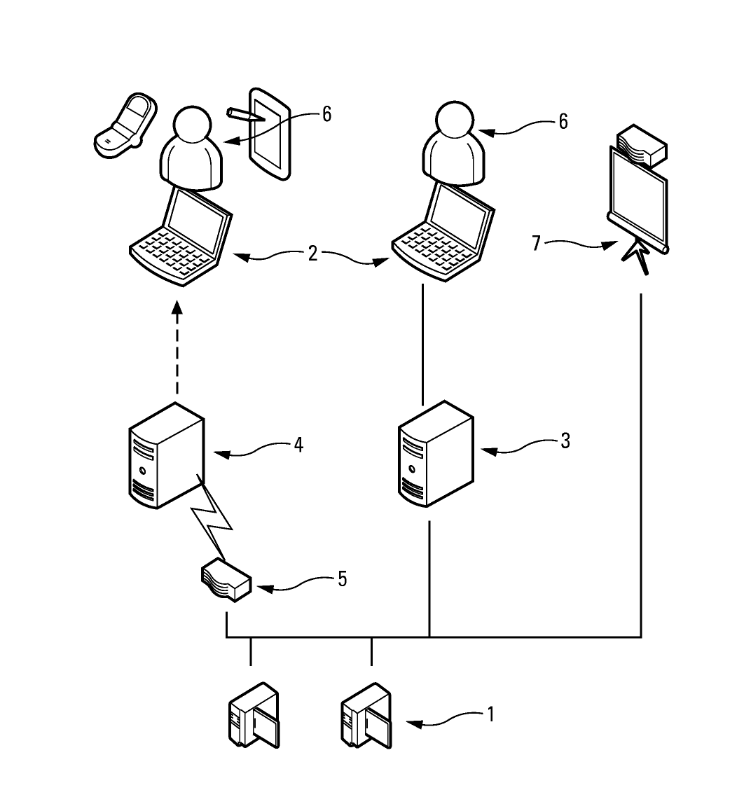

### FIELD OF THE INVENTION

The present invention lies in the field of transmitting digital data streams in real time, and in particular in real time transmission, via a communications network, of digital streams of audio data and of video data.

The invention finds a specific, but in no way limiting, application in the real time transmission of digital streams of audio and video data via a computer type communications network that may be local or remote, such as an intranet or the internet.

### BACKGROUND OF THE INVENTION

In the context of the invention, transmission takes place from a terminal for capturing sounds and images, such as a camera, to a remote reader terminal via a computer network. The sound is captured, in particular by a microphone, and transcribed into audio digital data, while the image sequences are captured and then transcribed into video digital data.

This audio data and video data is then transmitted via a communications network, in particular a computer network, to a terminal that is remote from said capture terminal. The remote terminal is capable of reading said data, i.e. it possesses sound-playback means, such as loudspeakers, and image-viewing means, such as a screen.

It should be observed that the transmission of the invention takes place in real time. In other words, the capture, transcription, transmission, and playback take place directly and continuously.

In known manner, the audio data and the video data are transmitted over a communications network simultaneously using a single data stream. In other words, the two kinds of data are associated and transmitted together via said network.

One known computer technology for performing this type of real time transmission is “streaming”. It makes it possible, at the reader terminal, continuously to view and to listen to the video and audio data as transmitted over a computer network, such as the internet. Reading takes place as and when the data is received, before the end of downloading all of the data.

That type of simultaneous transmission of streams of audio data and video data suffers from a major drawback that is common to all of the technologies used. The quantity of audio and video data that is being transmitted often exceeds the real data rate that the network can deliver, thereby giving rise to jerkiness or to breaks not only in the playback of the video stream, but also in the playback of the audio stream.

To some extent, this jerkiness is associated with the fact that the audio+video stream is transmitted over a single communications port of said network.

That is why most applications that make use of streaming technology have recourse to a “buffer”, i.e. a memory space in which the data is stored temporarily prior to being read. The buffer enables a maximum quantity of data for reading to be stored, thereby ensuring continuity in the playback of the streams, even in the event of network congestion or a drop in data rate. Nevertheless, depending on the size of the buffer, the time required for filling it leads to a time lapse that is objectionable for communication that is wanted to be in real time, e.g. in a conversation.

Another known technology stemming from the above is real time streaming protocol (RTSP) that avoids the use of a buffer and for which the storage time may remain a drawback in the context of a connection that it is desired to have in real time. Nevertheless, that technology still presents the disadvantage of jerkiness or even of offsets between the playback of the audio data stream and the playback of the video data stream.

### OBJECT AND SUMMARY OF THE INVENTION

An object of the present invention is to mitigate the drawbacks of the state of the art by proposing to separate the audio data stream and the video data stream while they are being transmitted. In particular, the invention sets out to isolate the audio data stream.

This feature makes it possible to avoid any jerkiness, latency, momentary stopping (freezing) or offset between the times at which the data streams are played back by the remote reader terminal.

Furthermore, the invention makes it possible to transmit only the video data stream or to transmit two distinct data streams, an audio stream and a video stream.

To do this, the present invention provides a method of transmitting digital streams of audio data and of video data in real time via a computer type communications network.

Within such a method, said transmission takes place directly from a transmitter terminal to a remote terminal for receiving and playing back said data.

Furthermore, said method consists in:
transmitting the video data stream on its own via a first communications port of said network; and
under the action of said remote terminal, transmitting the audio stream separately via a second communications port.

According to another characteristic, said transmitter terminal continuously captures sounds and images and transcribes them respectively into two distinct digital streams of audio data and of video data.

### BRIEF DESCRIPTION OF THE DRAWING

Other characteristics and advantages of the invention appear from the following detailed description of non-limiting embodiments of the invention, given with reference to the accompanying figure, in which:
the sole FIGURE is a diagram of the architecture implemented by the real time transmission method of the invention.

### MORE DETAILED DESCRIPTION

The present invention relates to transmitting a digital stream of audio and video data in real time, directly, and continuously.

In particular, the transmission takes place from at least one transmitter terminal 1 to at least one receiver terminal 2 via a computer type communications network.

In this respect, said computer network may be a local network such as an intranet, or a remote network such as the internet. Both types of network are shown in the accompanying FIGURE.

The right-hand portion represents a local network, having its elements and terminals connected together by wire or wirelessly, e.g. by radio, in particular using WiFi wireless network technology. Under such circumstances, a local server 3 serves to connect the terminals 1 and 2 together.

The left-hand portion is a simplified diagram of a remote or global network having a remote server 4 connected to the transmitter terminal 1 via connection means 5 for connection to said network, such as a router. Furthermore, said receiver terminal is connected via means suitable for connecting to said global network, to said remote server 4 that serves to provide the connection with the transmitter terminal 1.

It should be observed that said transmitter terminal 1 may be a device for capturing sounds and images continuously, such as a camera. Such a capture device includes means suitable for transcribing said sounds and images into two distinct digital streams respectively comprising audio data and video data.

Furthermore, said receiver terminal 2 may be a device including means suitable for playing back the sounds and images received in the form of two digital streams comprising audio data and video data. To do this, said receiver terminal 2 may include at least one loudspeaker for playing back sounds, and display or viewing means, such as a screen, for continuously playing back images, i.e. video. The receiver terminal may advantageously be a computer, a cell phone, a personal digital assistant, or any other appropriate terminal.

In a preferred embodiment, said transmitter terminal 1 includes connection means for connecting to said network, in particular in the form of a so-called “network” card. The card may include a standard connector suitable for receiving e.g. an RJ45 cable.

In particular, said transmitter terminal 1 may be powered by said RJ45 cable using the power over Ethernet (PoE) protocol and technology that serves to deliver the electricity needed to operate a device over at least one pair, and preferably two pairs, of the eight wires making up a cable of this type. The other wires are for data transmission.

More particularly, the wires numbered 1, 2, 3, and 6 may be used for conveying data, while the other wires, that are not used for data, may convey electricity.

The PoE protocol is capable of delivering a voltage of up to 48 volts (V) of direct current (DC) up to a maximum of 400 milliamps (mA) via two pairs of a network cable. The resulting theoretical maximum power is 15.4 watts (W), however it is found in reality to be 12.95 W because of losses in the range 10% to 20% of the available energy as a result of the resistance of the cables, giving rise to heat losses by the Joule effect.

Another power supply solution may be envisaged using so-called “phantom” power technology that serves to convey DC up to 48 volts via pairs of wires that are also used for transmitting data.

It should be observed that the RJ45 cable used may then be of the third or fifth category (respectively CAT 3 or CAT 5), preferably of the fifth category (CAT 5), or indeed of the sixth category (CAT 6). These various categories make it possible to use the following advances in the Ethernet protocol: 10BASE-T, 100BASE-TX, and 1000BASE-T, respectively for data speeds of 10 megabits per second (Mbit/s), 100 Mbit/s, and 1000 Mbit/s.

Furthermore, said cable may be shielded in order to improve the transmission of data and electrical power, while avoiding any external interference.

Under such circumstances, the transmitter terminal 1 is made independent, thereby making it easier to install, deploy, and potentially relocate.

Furthermore, another terminal 7 may be connected to all of the transmitter terminals 1 so as to view and monitor the streams, the connections, and the transmission of the data streams.

Within this architecture, a user 6 seeking to make a connection with said transmitter terminal 1 begins by making a connection to a virtual portal via a browser installed on the receiver terminal 2, said portal being hosted on one or other of the said servers 3 or 4, as appropriate.

From the portal, the user can initiate transmission, in particular using a procedure for connection, identification, and authentication, and, once connected, can then proceed with actions. These actions serve to configure and control the transmitter terminal 1 to which said user 6 is connected.

In this context, the present invention seeks to be capable of transmitting the audio and video digital data taken by the transmitter terminal 1, i.e. the camera, to said receiver terminal 2, in real time, and without jerkiness, latency, interruptions, or freezing.

To do this, an essential characteristic lies in isolating the audio data stream.

During transmission, the method of the invention transmits only the video data stream via a first communications port of said network.

In particular, with a remote connection, said port may be the port 80 that is reserved for consulting a hypertext transfer protocol (HTTP) server by means of a web browser (where web is short for “world-wide web”).

With a local connection, it is possible for some other port to be allocated and configured on opening for the purpose of making the connection.

The video stream then passes via the server 3 or 4 that redirects it to the receiver terminal 2.

It should be observed that this transmission may take place in streaming mode, in particular using the RTSP protocol. The only difference being that it is solely the video data stream that is transmitted in this way.

At this stage, the audio data stream is not transmitted. The separation performed in said transmitter terminal 1 makes it possible to send only the video data stream.

Furthermore, under the action of said receiver terminal 2, in particular under the action of the user 6 via a browser, the method of the invention enables the audio stream to be transmitted in separate manner via a second communications port.

In other words, the user 6 chooses to receive the sound in addition to the video and requests the transmitter terminal to act in this way.

In a preferred embodiment, said port that is reserved for transmitting the audio stream may be the port 1500 for a local connection or 1501 for a remote connection.

In another embodiment, said action of the user 6 may give rise to a changeover. Under such circumstances, the video data stream is transmitted by streaming, if it was not already being so transmitted, in particular by means of the RTSP protocol.

The video data stream may possibly be transmitted to the browser and then, after the action, it is subsequently changed over to streaming mode.

Under such circumstances, the first port is free to receive said audio data stream and the second port may then be said first port.

In another embodiment, the user 6 may perform an additional action to send the return channel to said transmitter terminal 1, still in real time. To do this, said receiver terminal 2 opens a subsidiary port for continuous transmission of a second audio data stream directly to said transmitter terminal 1. The second audio data stream may be captured at said receiver terminal 2, in particular via a microphone, and played back at said transmitter terminal 1.

It should be observed that the portal accessible to the user 6 presents menus, windows, and buttons that are displayed and that can be selected using said browser in order to perform said above-mentioned actions.

Furthermore, in order to enable the user to be connected to the portal and the data streams to be transmitted from the transmitter terminal 1, the server 3 or 4 may request the installation and local execution of a dedicated application in temporary or permanent manner.

In particular, such an application may include the software components needed for decoding the audio and video data streams. In order to improve the transmission of these streams, the transmitter terminal 1 performs a processing operation serving in particular to reduce the size of the data derived from capture.

In a preferred embodiment, said software components may be in the form of a coder-decoder (CODEC), i.e. a method of compressing and decompressing a digital signal.

In a particular embodiment, the audio data stream may also be put into packets in a specific format, in particular packets having a size of 4068 bits corresponding to the audio pulse code modulation (PCM) format at 16 kilohertz (kHz), using 16 bits in mono.

Thus, the method of the invention makes it possible to transmit audio and video data in real time, without interruptions, jerkiness, or latency, by separating their respective streams.

The present invention finds a particular, but in no way limiting, application in connecting a camera installed within a hospital service, such as a maternity ward, to a remote user 6, e.g. a member of the patient's family.

Advantageously, the transmitter terminal, i.e. the video camera, is provided with an on/off feature. This would allow e.g. the medical people to turn off the data transmission in case of any king of medical action provided to the baby. Such on/off feature can comprise a button, a voice control or any type of server, e.g. a digital sensor. This latter feature would allow to provide identification of the person switching the system on and off, and thus any required tracability.

Naturally, the invention is not limited to the examples shown and described above, which examples may be varied and modified without thereby going beyond the ambit of the invention.

What is claimed is:

1. A method of transmitting digital streams of audio data and of video data in real time via a computer type communications network, said transmission taking place directly from a transmitter terminal to a remote terminal for receiving and playing back said data, said transmitter terminal being a device for capturing sounds and images continuously, such as a video camera, wherein the method consists in:
transmitting only the video data stream via a first communications port of said network; and
under the action of said remote terminal, transmitting the audio stream separately via a second communications port.

2. A real time transmission method according to claim 1, wherein said transmitter terminal continuously captures sounds and images and transcribes them respectively into two distinct digital streams of audio data and of video data.

3. A real time transmission method according to claim 1, wherein under said action the transmission of said video data stream is changed over to streaming via the RTSP protocol.

4. A real time transmission method according to claim 1, wherein said receiver terminal opens a subsidiary port for transmitting a second audio data stream continuously and directly to said transmitter terminal, the second stream being captured at said receiver terminal and being played back at said transmitter terminal.
